(19) United States
(12) Patent Application Publication
(10) Pub. No.: US 2012/0044470 A1
(43) Pub. Date: Feb. 23, 2012

(54) Substrate for Use in Metrology, Metrology Method and Device Manufacturing Method

(75) Inventors: Hendrik Jan Hidde SMILDE, Veldhoven (NL); Maurits Van Der Schaar, Eindhoven (NL); Kaustuve Bhattacharyya, Veldhoven (NL)

(73) Assignee: ASML Netherlands B.V., Veldhoven (NL)

(21) Appl. No.: 13/190,998

(22) Filed: Jul. 26, 2011

Related U.S. Application Data
(60) Provisional application No. 61/374,766, filed on Aug. 18, 2010.

(51) Int. Cl. G03B 27/42; G01N 21/00

(52) U.S. Cl. 355/53; 355/72; 355/77; 356/237.2

(57) ABSTRACT

A pattern from a patterning device is applied to a substrate. The applied pattern includes device functional areas and metrology target areas. Each metrology target area comprises a plurality of individual grating portions, which are used for diffraction based overlay measurements or other diffraction based measurements. The gratings are of the small target type, which is small than an illumination spot used in the metrology. Each grating has an aspect ratio substantially greater than 1, meaning that a length in a direction perpendicular to the grating lines which is substantially greater than a width of the grating. Total target area can be reduced without loss of performance in the diffraction based metrology. A composite target can comprise a plurality of individual grating portions of different overlay biases. Using integer aspect ratios such as 2:1 or 4:1, grating portions of different directions can be packed efficiently into rectangular composite target areas.

### CROSS REFERENCE TO RELATED APPLICATIONS

This application claims benefit under 35 U.S.C. §119(e) to U.S. Provisional Application No. 61/374,766, filed Aug. 18, 2011, which is incorporated by reference herein in its entirety.

### BACKGROUND

1. Field of the Present Invention

The present invention relates to methods and apparatus for metrology usable, for example, in the manufacture of devices by lithographic techniques and to methods of manufacturing devices using lithographic techniques.

2. Background Art

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g., including part of, one, or several dies) on a substrate (e.g., a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti parallel to this direction. It is also possible to transfer the pattern from the patterning device to the substrate by imprinting the pattern onto the substrate.

In lithographic processes, it is desirable frequently to make measurements of the structures created, e.g., for process control and verification. Various tools for making such measurements are known, including scanning electron microscopes, which are often used to measure critical dimension (CD), and specialized tools to measure overlay, the accuracy of alignment of two layers in a device. Recently, various forms of scatterometers have been developed for use in the lithographic field. These devices direct a beam of radiation onto a target and measure one or more properties of the scattered radiation—e.g., intensity at a single angle of reflection as a function of wavelength; intensity at one or more wavelengths as a function of reflected angle; or polarization as a function of reflected angle—to obtain a “spectrum” from which a property of interest of the target can be determined. Determination of the property of interest may be performed by various techniques: e.g., reconstruction of the target structure by iterative approaches such as rigorous coupled wave analysis or finite element methods; library searches; and principal component analysis.

The targets used by conventional scatterometers are relatively large, e.g., 40 μm by 40 μm, gratings and the measurement beam generates a spot that is smaller than the grating (i.e., the grating is underfilled). This simplifies mathematical reconstruction of the target as it can be regarded as infinite. However, in order to reduce the size of the targets, e.g., to 10 μm by 10 μm or less, e.g., so they can be positioned in amongst product features, rather than in the scribe lane, so-called “small target” metrology has been proposed, in which the grating is made smaller than the measurement spot (i.e., the grating is overfilled). Placing the target in amongst the product features increases accuracy of measurement because the smaller target is affected by process variations in a more similar way to the product features and because less interpolation may be needed to determine the effect of a process variation at the actual feature site. Typically small targets are measured using dark field scatterometry in which the zeroth order of diffraction (corresponding to a specular reflection) is blocked, and only higher orders processed. Examples of dark field metrology can be found in international patent applications WO 2009/078708 and WO 2009/106279 which documents are hereby incorporated by reference in their entirety. In some techniques, for example, multiple pairs of differently biased gratings are required for accurate determination for overlay. The use of multiple pairs of gratings also increases the space on the substrate that needs to be devoted to metrology targets and hence is unavailable for product features. Even where targets are placed within scribe lanes, space is always at a premium. It will always be desired to shrink the targets.

Shrinking the gratings results in three interrelated problems:

1. Edge effects due to the visibility of the grating edges within the illumination spot may become important, even when using dark field techniques.
2. The point-spread-function at the level of the pupil plane is no longer determined only by the illumination spot shape and size, but becomes dominated by the grating size and shape. This will cause undesired interference (smearing) between corresponding coherent pupil plane points of the different diffraction orders. The problem of the point spread function is discussed in international patent application WO 2010/025950 A1, which is incorporated by reference herein in its entirety. There it is proposed to put the grating lines at an angle (e.g., 45 degrees) to the illumination/detection direction, so that smeared orders are further apart.
3. For diffraction into discrete orders, one should have a repeating unit (in one or more directions). This is formed by the lines that repeat with a frequency defined by the grating pitch. If the target is made smaller and the pitch is large (e.g., about 1000 nm), then the number of lines to form a repeating structure become fewer. Sometimes it is desired to make so-called “interlaced” gratings that have lines of two different exposures non-overlapping in the same layer. The pitch of such case is rather large, such that for a 4×4 μm² grating only maximum four lines can be admitted for each exposure. This is barely sufficient to consider a repeating unit.

The effects may be exacerbated by aberrations in the optical system, forward as well as backward through the objective lens.

### SUMMARY

It is desirable to provide a small target which enables a reduction in space occupied, while avoiding or at least mitigating one or more of the associated problems, mentioned above.

According to an embodiment of the present invention, there is provided a substrate comprising a target. The target has at least one individual grating portion having a structure periodic in a first direction for use in diffraction-based metrology. The grating portion has a length in the first direction and a width in a second direction, perpendicular to the first direction. An aspect ratio of the grating portion, being the ratio of the length to the width, is substantially greater than 1.

In one example, the elongated form of a grating having such an aspect ratio allows the occupied area to be reduced while mitigating one or more of the problems associated with shrinking the grating. The aspect ratio of the individual grating portion may be greater than 1.5. The aspect ratio may be substantially an integer, for example 2, 3 or 4, so that gratings with X and Y orientation can be packed efficiently into a rectangular target area.

Another embodiment of the present invention provides a method of inspecting a substrate having a target for diffraction-based metrology. The target has at least one individual grating portion having a structure periodic in a first direction. The method comprises illuminating the target with illumination from one or more predetermined directions and detecting radiation diffracted by the periodic structure in directions spread angularly into one or more diffraction orders. The illumination falls on parts of the substrate other than the individual grating portion. An image of the target including the other parts is formed using a selection from among the diffraction orders. The image is analyzed to select an image portion corresponding to the individual grating portion. The individual grating portion has a length in the first direction and a width in a second direction, perpendicular to the first direction. An aspect ratio of the grating portion, being the ratio of the length to the width, is substantially greater than 1.

In a further embodiment of the present invention there is provided a device manufacturing method comprising transferring a functional device pattern from a patterning device onto a substrate using a lithographic apparatus while simultaneously transferring a metrology target pattern to the substrate, measuring the metrology target pattern by diffraction based metrology and applying a correction in subsequent operations of the lithographic apparatus in accordance with the results of the diffraction based metrology. The metrology target pattern comprises at least one individual grating portion having a structure periodic in a first direction. Each of the grating portions having a length in the first direction and a width in a second direction, perpendicular to the first direction. An aspect ratio of the grating portion, being the ratio of the length to the width, is substantially greater than 1.

The corrections may be applied for example to reduce overlay error in subsequent patterning operations. By including different gratings with periodicity in orthogonal directions, overlay error can be measured and corrected in both X and Y directions.

Further features and advantages of the present invention, as well as the structure and operation of various embodiments of the present invention, are described in detail below with reference to the accompanying drawings. It is noted that the present invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the present invention and to enable a person skilled in the relevant art(s) to make and use the present invention

FIG. 1 depicts a lithographic apparatus according to an embodiment of the present invention.

FIG. 2 depicts a lithographic cell or cluster according to an embodiment of the present invention.

FIG. 3a shows a schematic diagram of a dark field scatterometer for use in measuring targets according to embodiments of the present invention.

FIG. 3b shows a detail of diffraction spectrum of a target grating for a given direction of illumination.

FIG. 3c shows a set of four illumination apertures useful for providing four illumination modes in using the scatterometer for diffraction based overlay measurements.

FIG. 4 depicts a known form of target and an outline of a measurement spot on a substrate.

FIG. 5 depicts an image of the targets of FIG. 4 obtained in the scatterometer of FIG. 3.

FIGS. 6a and 6b depict a novel form of reduced-area target according to an embodiment of the present invention, and for comparison a target reduced by simple scaling.

FIG. 7 compares the area used by four gratings shrunk in accordance with the present invention, compared with the gratings simply scaled down.

FIGS. 8a and 8b show the location of target patterns within a scribe lane region of a device pattern.

FIG. 8c shows one example of a reduced-area multiple-grating target, using embodiments of the present invention.

FIG. 9 shows the layout of a reduced-area target according to another embodiment of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

Before describing such embodiments in more detail, however, it is instructive to present an example environment in which embodiments of the present invention may be implemented.

FIG. 1 schematically depicts a lithographic apparatus LA. The apparatus includes an illumination system (illuminator) IL configured to condition a radiation beam B (e.g., UV radiation or DUV radiation), a patterning device support or support structure (e.g., a mask table) MT constructed to support a patterning device (e.g., a mask) MA and connected to a first positioner PM configured to accurately position the patterning device in accordance with certain parameters; a substrate table (e.g., a wafer table) WT constructed to hold a substrate (e.g., a resist coated wafer) W and connected to a second positioner PW configured to accurately position the substrate in accordance with certain parameters; and a projection system (e.g., a refractive projection lens system) PS configured to project a pattern imparted to the radiation beam B by patterning device MA onto a target portion C (e.g., including one or more dies) of the substrate W.

The illumination system may include various types of optical components, such as refractive, reflective, magnetic, electromagnetic, electrostatic or other types of optical components, or any combination thereof, for directing, shaping, or controlling radiation.

The patterning device support holds the patterning device in a manner that depends on the orientation of the patterning device, the design of the lithographic apparatus, and other conditions, such as for example whether or not the patterning device is held in a vacuum environment. The patterning device support can use mechanical, vacuum, electrostatic or other clamping techniques to hold the patterning device. The patterning device support may be a frame or a table, for example, which may be fixed or movable as required. The patterning device support may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam, which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g., employing a transmissive mask). Alternatively, the apparatus may be of a reflective type (e.g., employing a programmable mirror array of a type as referred to above, or employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g., water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD including, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may include an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may include various other components, such as an integrator IN and a condenser CO. The illuminator may be used to condition the radiation beam, to have a desired uniformity and intensity distribution in its cross section.

The radiation beam B is incident on the patterning device (e.g., mask) MA, which is held on the patterning device support (e.g., mask table MT), and is patterned by the patterning device. Having traversed the patterning device (e.g., mask) MA, the radiation beam B passes through the projection system PS, which focuses the beam onto a target portion C of the substrate W. With the aid of the second positioner PW and position sensor IF (e.g., an interferometric device, linear encoder, 2-D encoder or capacitive sensor), the substrate table WT can be moved accurately, e.g., so as to position different target portions C in the path of the radiation beam B. Similarly, the first positioner PM and another position sensor (which is not explicitly depicted in FIG. 1) can be used to accurately position the patterning device (e.g., mask) MA with respect to the path of the radiation beam B, e.g., after mechanical retrieval from a mask library, or during a scan. In general, movement of the patterning device support (e.g., mask table) MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the patterning device support (e.g., mask table) MT may be connected to a short-stroke actuator only, or may be fixed.

Patterning device (e.g., mask) MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the patterning device (e.g., mask) MA, the mask alignment marks may be located between the dies. Small alignment markers may also be included within dies, in amongst the device features, in which case it is desirable that the markers be as small as possible and not require any different imaging or process conditions than adjacent features. The alignment system, which detects the alignment markers is described further below.

The depicted apparatus could be used in at least one of the following modes:

1. In step mode, the patterning device support (e.g., mask table) MT and the substrate table WT are kept essentially stationary, while an entire pattern imparted to the radiation beam is projected onto a target portion C at one time (i.e., a single static exposure). The substrate table WT is then shifted in the X and/or Y direction so that a different target portion C can be exposed. In step mode, the maximum size of the exposure field limits the size of the target portion C imaged in a single static exposure.
2. In scan mode, the patterning device support (e.g., mask table) MT and the substrate table WT are scanned synchronously while a pattern imparted to the radiation beam is projected onto a target portion C (i.e., a single dynamic exposure). The velocity and direction of the substrate table WT relative to the patterning device support (e.g., mask table) MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.
3. In another mode, the patterning device support (e.g., mask table) MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

Lithographic apparatus LA is of a so-called dual stage type which has two substrate tables WTa, WTb and two stations—an exposure station and a measurement station—between which the substrate tables can be exchanged. While one substrate on one substrate table is being exposed at the exposure station, another substrate can be loaded onto the other substrate table at the measurement station and various preparatory steps carried out. The preparatory steps may include mapping the surface control of the substrate using a level sensor LS and measuring the position of alignment markers on the substrate using an alignment sensor AS. This enables a substantial increase in the throughput of the apparatus. If the position sensor IF is not capable of measuring the position of the substrate table while it is at the measurement station as well as at the exposure station, a second position sensor may be provided to enable the positions of the substrate table to be tracked at both stations.

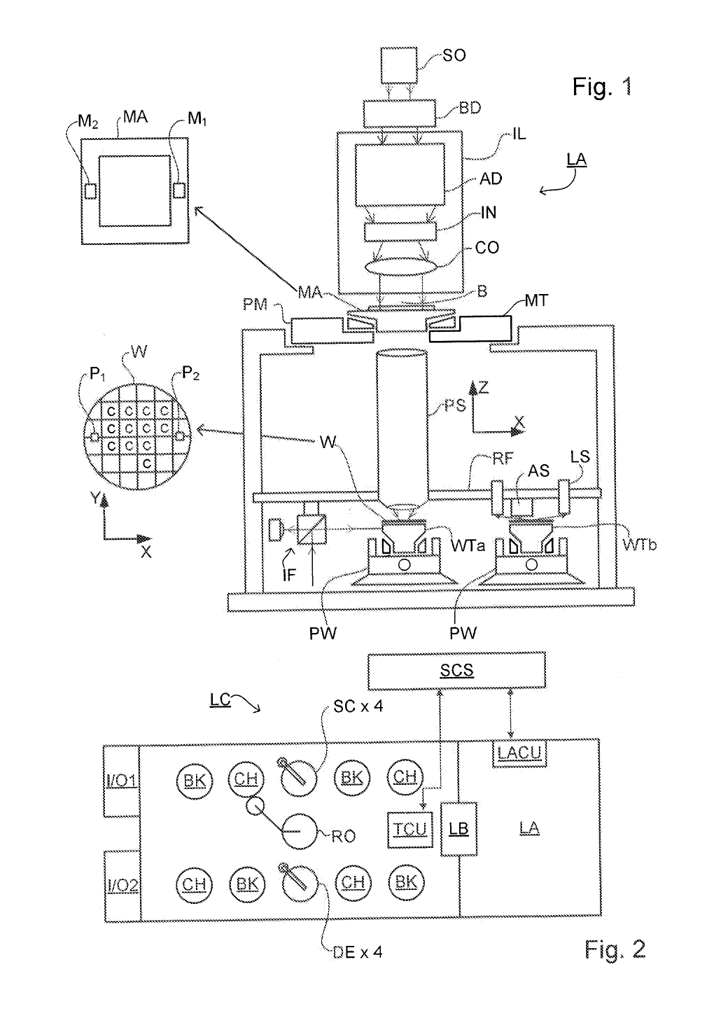

As shown in FIG. 2, the lithographic apparatus LA forms part of a lithographic cell LC, also sometimes referred to a lithocell or cluster, which also includes apparatus to perform pre- and post-exposure processes on a substrate. Conventionally these include spin coaters SC to deposit resist layers, developers DE to develop exposed resist, chill plates CH and bake plates BK. A substrate handler, or robot, RO picks up substrates from input/output ports I/O1, I/O2, moves them between the different process apparatus and delivers then to the loading bay LB of the lithographic apparatus. These devices, which are often collectively referred to as the track, are under the control of a track control unit TCU which is itself controlled by the supervisory control system SCS, which also controls the lithographic apparatus via lithography control unit LACU. Thus, the different apparatus can be operated to maximize throughput and processing efficiency.

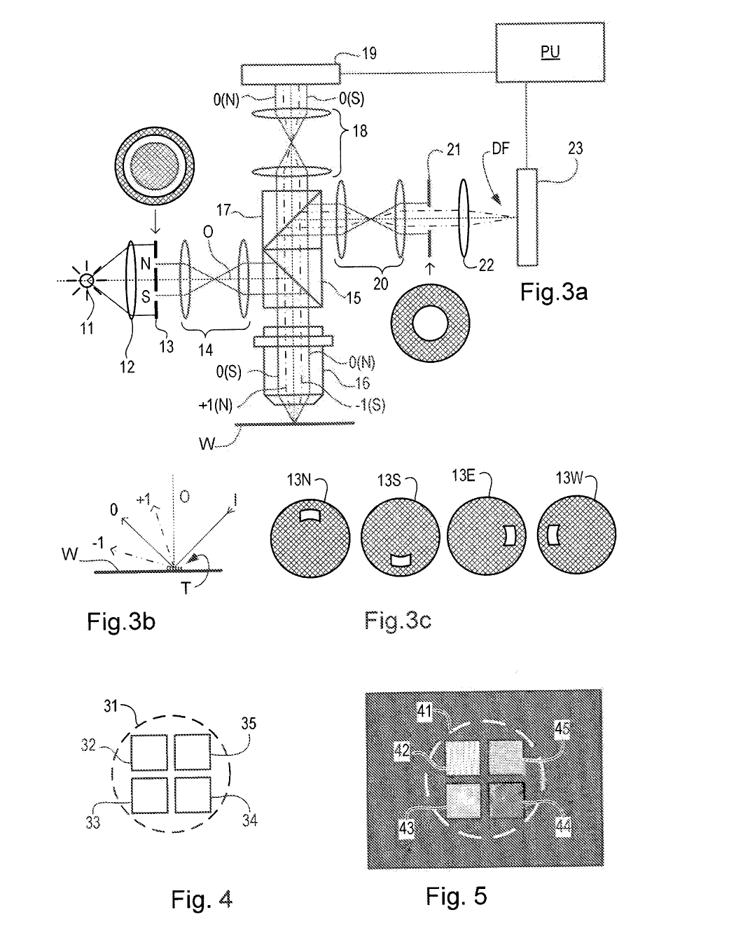

A dark field metrology apparatus according to an embodiment of the present invention is shown in FIG. 3a. A target grating T and diffracted rays are illustrated in more detail in FIG. 3b. The dark field metrology apparatus may be a stand-alone device or incorporated in either the lithographic apparatus LA, e.g., at the measurement station, or the lithographic cell LC. An optical axis, which has several branches throughout the apparatus, is represented by a dotted line O. In this apparatus, light emitted by source 11 (e.g., a xenon lamp) is directed onto substrate W via a beam splitter 15 by an optical system comprising lenses 12, 14 and objective lens 16. These lenses are arranged in a double sequence of a 4F arrangement. Therefore, the angular range at which the radiation is incident on the substrate can be selected by defining a spatial intensity distribution in a plane that presents the spatial spectrum of the substrate plane, here referred to as a (conjugate) pupil plane. In particular, this can be done by inserting an aperture plate 13 of suitable form between lenses 12 and 14, in a plane which is a back-projected image of the objective lens pupil plane. In the example illustrated, aperture plate 13 has an annular aperture centered on the optical axis of the illumination system formed by lenses 12, 14 and 16. Using the annular aperture, the measurement beam is incident on substrate W in a cone of angles not encompassing the normal to the substrate. The illumination system thereby forms an off-axis illumination mode. Other modes of illumination are possible by using different apertures. The rest of the pupil plane is desirably dark as any unnecessary light outside the desired illumination mode will interfere with the desired measurement signals.

As shown in FIG. 3b, target grating T is placed with substrate W normal to the optical axis O of objective lens 16. A ray of illumination I impinging on grating T from an angle off the axis O gives rise to a zeroth order ray (solid line 0) and two first order rays (dot-chain line +1 and double dot-chain line −1). It should be remembered that with an overfilled small target grating, these rays are just one of many parallel rays covering the area of the substrate including metrology target grating T and other features. Since the annular aperture in plate 13 has a finite width (necessary to admit a useful quantity of light, the incident rays I will in fact occupy a range of angles, and the diffracted rays 0 and +1/−1 will be spread out somewhat. According to the point spread function of a small target, each order +1 and −1 will be further spread over a range of angles, not a single ideal ray as shown.

At least the 0 and +1 orders diffracted by the target on substrate W are collected by objective lens 16 and directed back through beam splitter 15. Remembering that, when using the illustrated annular aperture plate 13, incident rays I impinge on the target from a cone of directions rotationally symmetric about axis O, first order rays −1 from the opposite side of the cone will also enter the objective lens 16, even if the ray −1 shown in FIG. 3b would be outside the aperture of objective lens 16. Returning to FIG. 3a, this is illustrated by designating diametrically opposite portions of the annular aperture as north (N) and south (S). The +1 diffracted rays from the north portion of the cone of illumination, which are labeled +1(N), enter the objective lens 16, and so do the −1 diffracted rays from the south portion of the cone (labeled −1(S)).

A second beam splitter 17 divides the diffracted beams into two measurement branches. In a first measurement branch, optical system 18 forms a diffraction spectrum (pupil plane image) of the target on first sensor 19 (e.g., a CCD or CMOS sensor) using the zeroth and first order diffractive beams. Each diffraction order hits a different point on the sensor, so that image processing can compare and contrast orders. The pupil plane image captured by sensor 19 can be used for focusing the metrology apparatus and/or normalizing intensity measurements of the first order beam. The pupil plane image can also be used for many measurement purposes such as reconstruction, which are not the subject of the present disclosure.

In the second measurement branch, optical system 20, 22 forms an image of the target on the substrate W on sensor 23 (e.g., a CCD or CMOS sensor). In the second measurement branch, an aperture stop 21 is provided in a plane that is conjugate to the pupil-plane. Aperture stop 21 functions to block the zeroth order diffracted beam so that the image of the target formed on sensor 23 is formed only from the first order beam. This is the so-called dark field image, equivalent to dark field microscopy. The images captured by sensors 19 and 23 are output to image processor and controller PU, the function of which will depend on the particular type of measurements being performed.

The particular forms of aperture plate 13 and field stop 21 shown in FIG. 3 are purely examples. In another embodiment of the present invention, on-axis illumination of the targets is used and an aperture stop with an off-axis aperture is used to pass substantially only one first order of diffracted light to the sensor. In yet other embodiments, 2nd, 3rd and higher order beams (not shown in FIG. 3) can be used in measurements, instead of or in addition to the first order beams.

In yet other embodiments, apertures in stops 13 and/or 21 are not circular or annular, but admit light at certain angles around the optical axis only. Bipolar illumination can be used to form dark field images of gratings aligned with the X and Y axes of substrate W. Depending on the layout of the apparatus, for example, illumination from north and south poles may be used to measure a grating with lines parallel to the X axis, while illumination with east and west poles is used to measure a grating with lines parallel to the Y axis.

In order to make the illumination adaptable to these different types of measurement, the aperture plate 13 may contain a number of aperture patterns on a disc which rotates to bring a desired pattern into place. Alternatively or in addition, a set of plates 13 could be provided and swapped, to achieve the same effect. A programmable illumination device such as a deformable mirror array can be used also. As just explained in relation to aperture plate 13, the selection of diffraction orders for imaging can be achieved by altering the field stop 21, or by substituting a field stop having a different pattern, or by replacing the fixed field stop with a programmable spatial light modulator. While the optical system used for imaging in the present examples has a wide entrance pupil, which is restricted by the field stop 21, in other embodiments or applications the entrance pupil size of the imaging system itself may be small enough to restrict to the desired order, and thus serve also as the field stop.

FIG. 3c shows a set of aperture plates 13N, 13S, 13E, 13W which can be used to make asymmetry measurements of small target gratings. For example, this can be done for the dark field overlay measurement method disclosed in international patent application PCT/EP2010/060894, which is incorporated by reference herein in its entirety. Using aperture plate 13N, for example, illumination is from north only, and only the +1 order will pass through field stop 21 to be imaged on sensor 23. By exchanging the aperture plate for plate 13S, then the −1 order can be imaged separately, allowing asymmetries in the target grating T to be detected and analyzed. The same principle applies for measurement of an orthogonal grating and illuminating from east and west using the aperture plates 13E and 13W. The aperture plates 13N to 13W can be separately formed and interchanged, or they may be a single aperture plate which can be rotated by, e.g., 90, 180 or 270 degrees. As mentioned already, the off-axis apertures illustrated in FIG. 3c could be provided in field stop 21 instead of in illumination aperture plate 13. In that case, the illumination could be on axis.

FIG. 4 depicts a composite target formed on a substrate. The composite target comprises four gratings 32 to 35 positioned closely together so that they will all be within the measurement spot 31 formed by the illumination beam of the metrology apparatus and thus are all simultaneously illuminated and simultaneously imaged on sensors 19 and 23. In an example dedicated to overlay measurement, gratings 32 to 35 are themselves composite gratings formed by overlying gratings that are patterned in different layers of the semi-conductor device formed on substrate W. Gratings 32 to 35 are differently biased in order to facilitate measurement of overlay between the layers in which the different parts of the composite gratings are formed. In one example, gratings 32 to 35 have biases of +D, −D, +3D, −3D respectively. This means that one of the gratings has its components arranged so that if they were both printed exactly at their nominal locations one of the components would be offset relative to the other by a distance D. A second grating has its components arranged so that if perfectly printed there would be an offset of D but in the opposite direction to the first grating and so on. While four gratings are illustrated, a practical embodiment might require a larger matrix to obtain the desired accuracy. For example, a 3×3 array of nine composite gratings may have biases −4D, −3D, −2D, −D, 0, +D, +2D, +3D, +4D. Separate images of these gratings can be identified in the image captured by sensor 23.

FIG. 5 shows an example of an image that may be formed on and detected by the sensor 23, using the target of FIG. 4 in the apparatus of FIG. 3, using the aperture plates 13N and the like from FIG. 3c. While the pupil plane image sensor 19 cannot resolve the different individual gratings 32 to 35, the image sensor 23 can do so. The dark rectangle represents the field of the image on the sensor, within which the illuminated spot 31 on the substrate is imaged into a corresponding circular area 41. Within this, rectangular areas 42-45 represent the images of the small target gratings 32 to 35. If the gratings are located in product areas, product features may also be visible in this image. Image processor and controller PU processes these images to identify the separate images 42 to 45 of gratings 32 to 35. This can be done by pattern matching techniques, so that the images do not have to be aligned very precisely at a specific location within the sensor frame. Reducing the need for accurate alignment in this way greatly improves throughput of the measuring apparatus as a whole.

Once the separate images of the gratings have been identified, the intensities of those individual images can be measured, e.g., by averaging or summing selected pixel intensity values within the identified areas Intensities and/or other properties of the images can be compared with one another. Using different apertures at 13 and 21, different measurements can be taken. These results can be combined to measure different parameters of the lithographic process. Overlay performance is an important example of such a parameter.

Using for example the method described in application PCT/EP2010/060894, overlay error between the two layers containing the component gratings 32 to 35 is measured through asymmetry of the gratings, as revealed by comparing their intensities in the +1 order and −1 order dark field images. Using the metrology apparatus of FIG. 3 with an aperture plate 13 having only a single pole of illumination (e.g., north, using plate 13N), an image of the gratings 32 to 35 is obtained using only one of the first order diffracted beams (say +1). Then, either the substrate W or the aperture plate 13 is rotated by 180° so that a second image of the gratings using the other first order diffracted beam can be obtained. For example, the aperture plate may be changed from 13N to 13S while keeping the optical system otherwise the same. Consequently the −1(S) diffracted radiation is captured in the second image. As a result, two images will be obtained, each looking generally like that shown in FIG. 5, but with different intensities of the grating images 42 to 45. Note that by including only half of the first order diffracted radiation in each image, the ‘images’ referred to here are not conventional dark field images that would be produced using the apertures illustrated in FIG. 3a. The individual grating lines will not be resolved. Each grating will be represented simply by an area of a certain grey level. The overlay can then be determined by the image processor and controller PU by comparing the intensity values obtained for +1 and −1 orders, and from knowledge of the overlay biases of the gratings 32 to 35. As described in the prior application, X and Y direction measurements can be combined in one illumination step by providing a first an aperture plate with, say, apertures at north and east portions, while a second aperture plate is provided with apertures at south and west.

If the gratings are particularly close together on the substrate, it is possible that the optical filtering in the second measurement branch may cause cross talk between signals. In that event, the central opening in the spatial filter formed by field stop 21 should be made as large as possible while still blocking the zeroth order.

It will be appreciated that the target arrays provided in this embodiment of the present invention can be located in the scribe lane or within product areas. By including multiple targets within an area illuminated by the measurement spot 31 and imaged on sensor 23, several advantages may accrue. For example, throughput is increased by acquisition of multiple target images in one exposure, less area on the substrate need be dedicated to metrology targets and accuracy of overlay measurements can be improved, especially where there is a non-linear relationship between the intensities of the different first order diffraction beams and overlay.

Although the use of small targets and image processing allows more measurements to be taken within a given target area, there are still conflicts between space used and the quality of the measurements obtained. As discussed above, many different gratings may be required with different biases, to measure overlay accurately. Different biases need to be provided in both X and Y directions. Additional targets may be required for measuring overlay between different layer pairs in a stack of layers. For these reasons, there is still an urge to reduce the sizes of the individual gratings. Unfortunately, as described in the introduction above, the purity of the diffracted orders, and the separation between them, are also reduced when the grating size is reduced. The factors mentioned in the introduction come into play: (1) edge effects become significant; (2) the point spread function smears the diffraction orders and (3) the number of repeating units becomes too small for the grating to generate discrete orders of diffraction. Depending on specifics of the grating and the measurement application, one or other of these factors may become a source of unacceptable error.

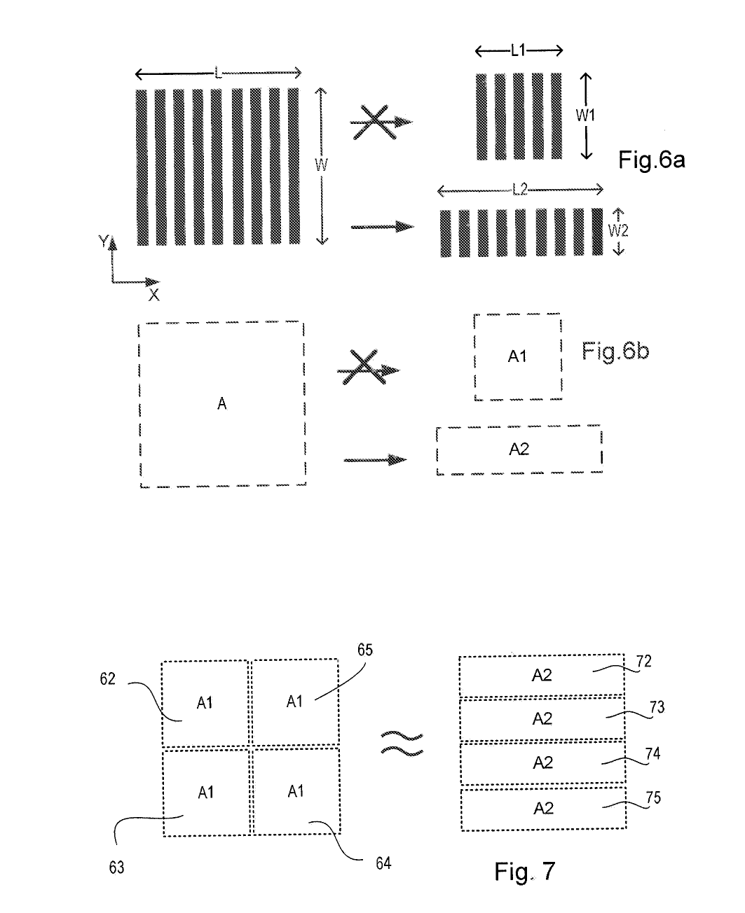

As seen in FIG. 6, this invention at its most basic level proposes a small target design which is more elongated in the direction perpendicular to the grating lines. As a reference point for discussion, FIG. 6a, left hand side, shows a square diffraction grating, with width W parallel to the grating lines and with length L perpendicular to the lines. For the purposes of this description, the terms ‘width’ and ‘length’ will be used with this meaning, irrespective of whether the lines are parallel to the X axis of the substrate or (as shown in FIG. 6a) parallel to the Y axis.

For shrinking this grating, FIG. 6a illustrates two options: (i) to reduce both length and width in proportion to achieve a square with new length and width values L1, W1, or (ii) to reduce width more strongly than length, to achieve an elongated grating with length L2 and width W2. As illustrated by the dashed outlines in FIG. 6(b), the original grating has an area A=W×L, the reduced square grating has an area A1=W1×L1, and the elongated reduced grating has an area A2=W2×L2. The areas of A1 and A2 may be similar, but the aspect ratios of the gratings, defined here as L1:W1 and L2:W2 respectively, are very different. In particular, while the square gratings have an aspect ratio L:W or L1:W1 which is equal to 1 (unity), the second example has an aspect ratio L2:W2 which is substantially greater than 1. This preferred grating may be referred to as an elongated grating, whether L2 is actually longer, the same or a little shorter than the previous grating length L.

FIG. 7 shows options for arranging arrays or sets of individual gratings to form a composite metrology target on a substrate. Suppose that the large square area A represents the area of one of the known small square gratings 32 to 35, seen in FIG. 3. At the left side in FIG. 7, the individual gratings have been halved in each dimension to form smaller square gratings 62, 63, 64, 65. These are shown in a 2×2 square array, each with area A1. The whole composite grating now fits within area A (instead of occupying 4×A as previously). At the right hand side in FIG. 7, four alternative gratings 72 to 75 have been reduced by a factor of four in the width dimension only, but kept their length. (We assume, for ease of comparison, that the lengths L2 of these gratings equal the original length L, but this is not a requirement of the present invention.) The area A2 equals area A1. The 4:1 aspect ratio of the gratings 72 to 75 means that four of them lying side-by-side still fit within the same square area A.

While the area A2 may be the same as area A1, the choice of the elongated reduced grating brings benefits over simply reducing the square grating without changing its aspect ratio. Put another way, the choice of the elongated reduced grating does not bring the penalties associated with reducing the size of the grating, which would otherwise be incurred in the effort to save substrate space. Edge effects in small gratings may arise for example due to overlay, aberrations, defocus and angle of incidence of the illumination. All of these effects are especially observed at the edges parallel to the grating lines. Therefore, for equivalent grating area, the edge effects are reduced (for a given grating area) by reducing the size of the sides parallel to the lines.

Additionally, especially for large pitch gratings, that the number of lines within a grating is not too much reduced for equivalent area. Known examples of a large pitch grating are so-called interlaced targets with a pitch of 1000 nm, which are left with a maximum of 5 lines, if the size is reduced to 5×5 μm². Elongating the grating slightly to 4×6 μm² or 3×8 μm² would gain significantly in number of lines, for no increase in area.

Concerning the diffraction from the lines, the diffracted 1^{st} and higher orders are separate from one another in the direction perpendicular to the lines (as seen in FIG. 3b). The coherent points in the pupil plane, lie therefore on a line perpendicular to the grating lines. For reduction of the risk of interference of these coherent orders, it is therefore important to reduce the size of the point-spread functions in this ‘length’ direction, and less important in the width direction. By increasing (or at least maintaining) the size of the grating in its length direction, the point-spread functions become therefore sharper in the direction perpendicular to the grating lines. This facilitates analysis based on diffracted orders such as is done using scatterometry apparatus such as that shown in FIG. 3.

The application of this invention is particularly useful in dark-field metrology of the type discussed above. The size of the metrology targets is significantly reduced, enabled by the dark-field measurement. However, also the pupil detection or bright-field metrology may benefit from the present invention and are included here. The exact grating dimensions and target design are to be optimized as function of the exact application of the present invention.

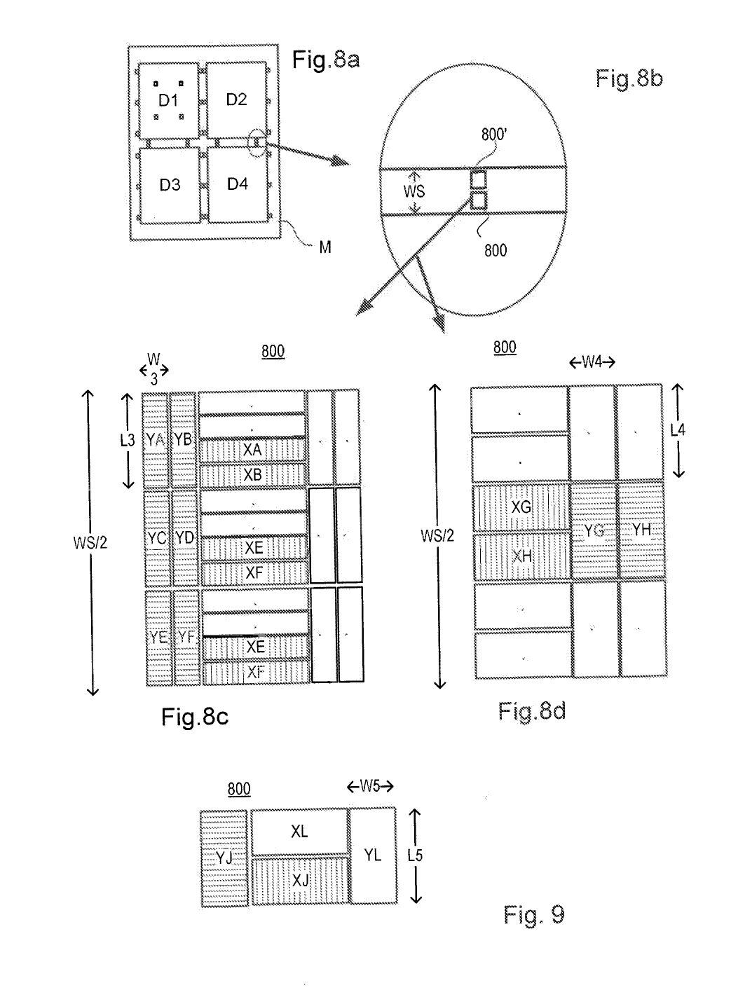

FIG. 8 shows just one example of a target design that uses elongate small target gratings of the type introduced above. At (a) there is shown schematically the overall layout of a patterning device M. As mentioned already, the metrology targets may be included in a scribe lane portion of the applied pattern, between functional device pattern areas. As is well known, patterning device M may contain a single device pattern, or an array of device patterns if the field of the lithographic apparatus is large enough to accommodate them. The example in FIG. 8a shows four device areas D1 to D4. Scribe lane marks such as targets 800 and 800′ are placed adjacent these device pattern areas and between them. On the finished substrate, such as a semiconductor device, the substrate W will be diced into individual devices by cutting along these scribe lanes, so that the presence of the targets does not reduce the area available for functional device patterns. Because targets are small in comparison with conventional metrology targets, they may also be deployed within the device area, to allow closer monitoring of lithography and process performance across the substrate. Some marks of this type are shown in device area D1. While FIG. 8a shows the patterning device M, the same pattern is reproduced on the substrate after the lithographic process, and consequently this the description applies to the substrate W as well as the patterning device.

FIG. 8b shows in more detail two targets 800 and 800′ as formed on the substrate W. FIGS. 8c and 8d show two possible example designs for a composite grating contained in target 800. In this example, a scribe lane between device areas D2 and D4 has a width WS of 50 μm. Half of this, that is 25 μm, is available for the scribe lane metrology target 800. In (c), individual gratings XA and YA have their lengths L3 and widths W3 with an aspect ratio of 4:1. These can be arranged in a compact arrangement such as the one shown, containing twelve individual X gratings and twelve individual Y gratings. Six of the X gratings are labeled XA to XF, while six of the Y gratings are labeled YA to YF. Within this number, there is plenty of opportunity to include a range of different bias values for overlay, for example, and to include targets for measuring overlay in different layers. The entire array fits within the half width of the scribe lane, shown as WS/2 in the drawing. In FIG. 8d there is another possible design, including six X and six Y gratings, each with length L4 and width W4 in an aspect ratio of 2:1. One pair of X gratings are labeled XG, XH and one pair of the Y gratings are labeled YG and YH. Again, the total target fits within the half width WS/2 of the scribe lane.

If the total composite target size for the original square gratings is assumed to have been 11×11 μm² with 5.5×5.5 μm² individual grating size, then FIG. 8d presents a composite target allowing the same number of gratings within approximately the same target area, but with more attractive properties as mentioned above. The aspect ratio of each individual grating in FIG. 8d is approximately 2:1. For example, L4 may be 8 μm while W4 is 4 μm, giving a composite target area of 8×16 μm² for the four individual gratings XG, XH, YG, YH. If the performance of the lithographic apparatus and process as a whole is sufficient, size can be reduced even more in the direction parallel to the lines and the solution of FIG. 8c becomes feasible. Here, within the same overall area 8×16 μm², L3 may be 8 μm while W4 is 2 μm. The aspect ratio is approximately 4:1. Note that these gratings are in fact longer than the square grating of dimension 5.5 μm, yet even more of them fit within the same area.

FIG. 9 shows yet another design for arranging gratings together where the aspect ratio L5 to W5 is 2:1. One pair of gratings is labeled XJ and YJ, while another pair is labeled XL and YL. This layout will be seen as a hybrid of those shown in FIGS. 8c and 8d, and could be used directly in place of one or more of the three rectangular blocks seen in those layouts. There is thus no requirement for all the individual grating portions within a composite target to have the same aspect ratio. It is readily possible for example to mix gratings having aspect ratios of 2:1 and 4:1 in a compact pattern. Square gratings may still have a place also.

Non-integer aspect ratios may be used, while the integer ratios have the advantage that X and Y gratings can be packed together in designs of the type illustrated in FIGS. 8 and 9. An aspect ratio of 3:1 is perfectly possible, but does not permit such compact packing, if equal numbers of X and Y gratings are desired. Where the X and Y gratings are not packed together in a composite target, the preference for integer aspect ratios need not be so strong, and the width and length can be optimized simply to obtain the desired metrology performance within a minimal area.

For application within the device pattern areas, as shown at D1 in FIG. 8a, the smaller elongated shape of a grating brings greater flexibility in placement and routing of product features around the target. X- and Y-direction overlay gratings may be split up, and positioned at different locations on the substrate. In this way it is possible to position the X- and Y-direction overlay gratings on the substrate in case there is not enough space on the substrate to position a composite target that comprises both the X- and Y-direction overlay gratings. Where the present description and claims talk of integer aspect ratios, it will be understood that these are approximations. In the examples shown, where a small margin of separation is provided between gratings, the individual grating may strictly have an aspect ratio slightly greater than the nominal, integer value. The margin may be important for example to allow individual images of the gratings to be separated by image processing.

Whatever detailed design is chosen, the aspect ratio W:L being substantially greater than unity brings important benefits to mitigate the problems of scaled-down targets which have been explained above. Edge effects are reduced as a percentage of grating area, in the length direction. The elongated small gratings have more lines than square small targets with the same area. This is especially important for small gratings combined with large pitches, for which the number of lines would be very small without the elongation. Because of the increased (or at least not reduced) number of lines, cross-talk between coherent orders in the pupil plane is reduced. This facilitates analyses based on separate measurement of diffraction orders in sensor 19 (FIG. 3), and the information transmitted by the field stop 21 to sensor 23 becomes better defined in the direction of diffraction.

Embodiments of the present invention have individual gratings with aspect ratios substantially greater than unity, for example greater than 1.5, or greater than 1.8. The gratings are designed to be overfilled, that is they are smaller than the illumination spot of the metrology apparatus used to inspect them. The spot size will of course vary according to the instrument. It may have a diameter up to 100 μm, for example, or less than 50 μm, or less than 30 μm. Individual grating portions may have a length (perpendicular to their grating lines) which is less than 15 μm, or less than 10 μm. A composite target comprising at least four gratings may for example be contained in a circle of diameter less than 50 μm or less than 30 μm. A composite target comprising at least four gratings may for example occupy a rectangular area on the substrate which is less than 200 μm², or less than 150 μm². Within such a composite target, the individual grating portions may each for example have a length greater than 6 μm and a width less than 6 μm.

While specific embodiments of the present invention have been described above, it will be appreciated that the present invention may be practiced otherwise than as described. In association with the physical grating structures of the novel targets as realized on substrates and patterning devices, an embodiment may include a computer program containing one or more sequences of machine-readable instructions describing a methods of producing targets on a substrate, measuring targets on a substrate and/or analyzing measurements to obtain information about a lithographic process. This computer program may be executed for example within unit PU in the apparatus of FIG. 3 and/or the control unit LACU of FIG. 2. There may also be provided a data storage medium (e.g., semiconductor memory, magnetic or optical disk) having such a computer program stored therein.

Although specific reference may have been made above to the use of embodiments of the present invention in the context of optical lithography, it will be appreciated that the present invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g., having a wavelength of or about 365, 355, 248, 193, 157 or 126 nm) and extreme ultra-violet (EUV) radiation (e.g., having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

The foregoing description of the specific embodiments will so fully reveal the general nature of the present invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description by example, and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, the Examiner is also reminded that any disclaimer made in the instant application should not be read into or against the parent application.

What is claimed is:

1. A substrate comprising:
a target, the target having at least one individual grating portion having a structure periodic in a first direction for use in diffraction-based metrology, the grating portion having a length in the first direction and a width in a second direction, perpendicular to the first direction, and
wherein an aspect ratio of the grating portion, being a ratio of the length to the width, is substantially greater than 1.

2. The substrate of claim 1, wherein the aspect ratio of the individual grating portion is greater than 1.5.

3. The substrate of claim 2, wherein the aspect ratio of the individual grating portion is substantially an integer.

4. The substrate of claim 1, wherein the grating portion has a length greater than 6 μm and a width less than 8 μm or less than 6 μm.

5. The substrate of claim 1, wherein the target is a composite target comprising a plurality of individual grating portions, each having an aspect ratio substantially greater than 1.

6. The substrate of claim 1, wherein the plurality of individual grating portions having aspect ratios substantially equal to integer values greater than 1, are arranged within a substantially rectangular composite target area.

7. The substrate of claim 6, wherein the composite target area is contained in a circle of diameter less than 50 μm and includes at least four individual grating portions, each grating portion having a length greater than 6 μm and a width less than 6 μm.

8. The substrate of claim 6, wherein the plurality of grating portions includes at least one first grating portion and at least one second grating portion, the length directions of first grating portions and second grating portions, and their directions of periodicity, being perpendicular to one another.

9. The substrate of claim 8, wherein a plurality of first grating portions are arranged side-by-side and parallel to one another, while a second grating portion is arranged perpendicularly across their ends.

10. The substrate of claim 8, wherein a number of first grating portions and second grating portions are equal.

11. The substrate of claim 6, wherein each individual grating portion is an overlay grating foamed in two patterned layers, and wherein different individual grating portions are formed with different overlay biases.

12. The substrate of claim 1, further comprising a plurality of functional device areas, wherein the target is located within a scribe lane region between two functional device areas.

13. The substrate of claim 1, further comprising at least one functional device area, wherein the target is located within the functional device area.

14. A patterning device comprising:
functional pattern features; and
target pattern features, the target pattern features being formed to produce a grating portion if a pattern is applied from the patterning device to a substrate,
wherein the grating portion has a structure periodic in a first direction for use in diffraction-based metrology, the grating portion having a length in the first direction and a width in a second direction, perpendicular to the first direction, and
wherein an aspect ratio of the grating portion, being a ratio of the length to the width, is substantially greater than 1.

15. The patterning device of claim 14, comprising functional pattern features and the target pattern features, the target pattern features being formed to produce the grating portion as an overlay grating if a pattern is applied on top of the pattern applied with the patterning device.

16. The patterning device of claim 15, wherein the target pattern features are formed to produce a plurality of overlay grating portions in a composite target, the plurality of overlay grating portions including portions with a different overlay bias.

17. A method of inspecting a substrate having a target for diffraction-based metrology, the target having at least one individual grating portion having a structure periodic in a first direction, the method comprising:
illuminating the target and detecting radiation diffracted by the periodic structure in directions spread angularly into one or more diffraction orders,
wherein the illumination falls on parts of the substrate other than the individual grating portion,
wherein an image of the target including the other parts is formed using a selection from among the diffraction orders,
wherein the image is analyzed to select an image portion corresponding to the individual grating portion,
wherein the individual grating portion has a length in the first direction and a width in a second direction, perpendicular to the first direction, and
wherein an aspect ratio of the grating portion, being a ratio of the length to the width, is substantially greater than 1.

18. The method of claim 17, wherein the aspect ratio of the individual grating portion is greater than 1.5.

19. The method of claim 17, wherein the aspect ratio of the individual grating portion is substantially an integer.

20. The method of claim 17, wherein the grating portion has a length greater than 6 μm and a width less than 8 μm or less than 6 μm.

21. The method of claim 17, wherein the target is a composite target comprising a plurality of individual grating portions, each having an aspect ratio substantially greater than 1, and wherein image portions corresponding to the plurality of individual grating portions are contained within the formed image, and are selected and analyzed separately.

22. The method of claim 21, wherein the plurality of individual grating portions have aspect ratios substantially equal to integer values greater than 1 and are arranged within a substantially rectangular composite target area.

23. The method of claim 22, wherein the composite target area comprises at least four individual grating portions, each grating portion having a length greater than 6 μm and a width less than 6 μm.

24. The method of claim 22, wherein the plurality of grating portions includes at least one first grating portion and at least one second grating portion, the length directions of first grating portions and second grating portions, and their directions of periodicity, being perpendicular to one another.

25. The method of claim 24, wherein a plurality of first grating portions are arranged side-by-side and parallel to one another, while a second grating portion is arranged perpendicularly across their ends.

26. The method of claim 24, wherein a number of first grating portions and second grating portions are equal.

27. The method of claim 17, wherein each individual grating portion is an overlay grating formed in two patterned layers, and wherein different individual grating portions are formed with different overlay biases.

28. The method of claim 17, wherein the target is located within a scribe lane region between two functional device areas on the substrate.

29. The method of claim 17, wherein the target is located within a functional device area of the substrate.

30. A device manufacturing method comprising:
transferring a functional device pattern from a patterning device onto a substrate using a lithographic apparatus while substantially simultaneously transferring a metrology target pattern to the substrate;
measuring the metrology target pattern by diffraction based metrology; and
applying a correction in subsequent operations of the lithographic apparatus in accordance with the results of the diffraction based metrology,
wherein the metrology target pattern comprises at least one individual grating portion having a structure periodic in a first direction, each of the grating portions having a length in the first direction and a width in a second direction, perpendicular to the first direction, and
wherein an aspect ratio of the grating portion, being a ratio of the length to the width, is substantially greater than 1.

31. The device manufacturing method of claim 30, wherein the metrology target pattern comprises a plurality of individual grating portions having different overlay biases, and wherein the corrections are applied to reduce overlay error in the subsequent operations.

32. The device manufacturing method of claim 31, wherein the metrology target pattern includes at least one first grating portion and at least one second grating portion, the length directions of first grating portions and second grating portions, and hence their directions of periodicity, being perpendicular to one another.

33. The device manufacturing method of claim 32, wherein a plurality of first grating portions are arranged side-by-side and parallel to one another, while a second grating portion is arranged perpendicularly across their ends.
